(19) United States
(12) Patent Application Publication
(10) Pub. No.: US 2025/0013216 A1
(43) Pub. Date: Jan. 9, 2025

(54) A METHOD FOR MAXIMISING THE ENERGY OUTPUT OF RENEWABLE ENERGY SOURCES

(71) Applicant: EASY OZE SP. Z O.O., Olsztyn (PL)

(72) Inventor: Krzysztof Bartczak, Glinojeck (PL)

(21) Appl. No.: 18/712,632

(22) PCT Filed: Nov. 24, 2022
(86) PCT No.: PCT/IB2022/061373

§ 371 Date: May 22, 2024

(30) Foreign Application Priority Data
Nov. 24, 2021 (PL) 439637

(51) Int. Cl. G05B 19/042

(52) U.S. Cl. CPC G05B 19/042; G05B 2219/2619

(57) ABSTRACT

Invention relates to a method for maximising the an yield of the energy generated from renewable energy sources in a given area according to the invention, using a minimum number of energy-generating elements and using an artificial intelligence module connected to a server, characterised in that it employs the artificial intelligence module comprising two neural networks, the first one of them being an RBF type (Radial Basis Function), and the second one being a PSO type (Particle Swarm Optimisation), wherein the first network (RBF) has a negative feedback loop comprising the second network (PSO) and aggregating the data generated by the second network (PSO).

### TECHNICAL FIELD

The invention relates to the field of installations of renewable energy sources (RES), and in particular to a method for maximising the output of energy from RES installations by planning the selection, distribution and arrangement of elements of an installation in a given area, using artificial intelligence in the form of a neural network in order to achieve the maximum energy output in a given area. This is done while retaining control of the maximum value of the energy produced by RES installations.

### PRIOR ART

The document EP2689466B1 discloses a solution which improves the usability of photovoltaic installations (PV installations) by taking into account shading information from neighbouring PV installations to predict the power generated by the respective PV installation. In particular, cloud movements and their shapes are taken into account, improving the accuracy of prediction. The disclosed system takes into account weather forecasts to activate an energy-generating device in a proper time, and for the photovoltaic installation to counteract a drop in the output power. Weather data are analysed by means of neural networks.

The document US2020358396A1 discloses a system for detecting, classifying and locating damage to solar panels by means of neural networks. The disclosed system use a cyber-physical system (CPS) to detect defects in the matrices of photovoltaic panels (PV). The algorithms of neural networks disclosed in the document are executed in neural networks with a positive feedforward loop to detect errors and identifications from monitoring devices which detect data and are activated in every single module of the matrices of photovoltaic panels.

The document CN110264012A discloses a method and system for predicting the combinations of elements of a system of renewable energy generators based on empirical mode decomposition, the method comprising the following steps: acquiring data on renewable energy possible to collect in a unit of time using the least-squares support vector algorithm and the RBF-type neural network algorithm by adopting an induced ordered weighted averaging operator in order to obtain the final predicted value.

The document US2012144828A1 discloses a system for managing renewable energy resources, which manages a delivery of the required energy from a multi-resource offshore renewable energy installation to an intelligent energy distribution network. The installation comprises numerous renewable energy resources components and is capable of variably and independently generating energy from each of them for micro-networks constituting an intelligent energy distribution network, so that the entire energy demand is satisfied from the renewable energy resources. An electrical grid infrastructure is also disclosed, in which the electrical energy production is balanced with its consumption, so that the energy storage requirements are minimised.

Solutions known from prior art use mechanisms predicting the output of energy from renewable sources based on standard mathematical models, which leads to low effectiveness of calculations due to the imperfection of the mathematical models. While others are based on artificial intelligence modules comprising a single type of neural networks, or a single type of neural networks enhanced with a standard metamathematical data processing model. These solutions lead to highly imprecise results in the event of using mathematical models, or very long and highly burdensome calculations, whose results are highly complex and require further mathematical processing, which also leads to low precision of results.

### Advantages of the Invention

Method according to the present invention involves the automatically performed determination of the impact of terrain conditions on the spatial distribution of renewable energy in the form of energy of the sun, the wind, or geothermal energy, on the maximum yield of the energy produced in a given area.

This solution enables the determination of preferable and unpreferable zones for a given type of RES, along with the selection of suitable types of RES energy production devices. The method according to the invention takes into account the cooperation of various types of devices producing energy from RES by maximising the obtained power, while maintaining a safe operating mode and deactivating the system upon exceeding the maximum predicted yield of the energy generated by the individual systems for producing energy from RES.

Method according to the invention enables establishing the maximum value of the produced energy—the energy yield, for a given area, taking into account the area, weather, geolocation and geothermal conditions, terrain, the structure of buildings, and the distribution of vegetation. The method according to the invention enables choosing and arranging energy-producing devices for obtaining the maximum possible value of energy yield, taking into account the time of day, seasons of the year, and the weather. In the event when unexpectedly preferable weather conditions occur accidentally for each type of energy-producing devices, e.g. a cloudless, winter day with a hurricane, which would unexpectedly increase the value of the produced energy above the value predicted by all devices for the production of energy, the method according to the invention will disconnect the energy-producing systems from the grid and protect them against damage.

### The Essence of the Invention

A method for maximising an yield of energy generated from renewable energy sources in a given area according to the invention, using a minimum number of energy-generating elements and using an artificial intelligence module connected to a server, comprising the steps of:
a) Transmitting to a server historical weather data for a given area, types of elements generating energy from renewable energy sources fulfilling the area requirements, as well as area geometry data, including data on: location of the area, terrain, shape and location of buildings in the area;
b) Transmitting the data from step a) to the artificial intelligence module;
c) Determining, by the artificial intelligence module, a vector field of solar irradiation intensity at a given time on every day in the year, for a given geometry of the area and objects located thereon, based on the data acquired in step b);
d) Determining, by the artificial intelligence module, a vector field of the wind direction and strength at a given time on every day in the year, for a given geometry of the area and the objects located thereon, based on the data acquired in step b);
e) Determining, by the artificial intelligence module, a vector field of the temperature and moisture of ground at a given time on every day in the year, for a given geometry of the area and the objects located thereon, based on the data acquired in step b);
f) Determining, by the artificial intelligence module, preferable and unpreferable zones for a given type of elements generating energy from renewable energy sources on the area, based on the data determined in steps d), e), and f);
g) Calculating a possible maximum yield of the energy generated by elements generating energy from renewable energy sources in a given area;
h) Selection the type of elements generating energy from renewable energy sources, and planning their spatial distribution in a given area, so as to maximise the yield of the energy generated by these elements;
i) Installing elements generating energy from renewable energy sources according to the plan developed in step h), and connecting them to a power grid through a shared energy coupling;
j) Activating the energy coupling, and transmitting the energy produced by the installation made in step i) to the power grid;
k) Disconnecting the energy coupling, and interrupting the transmission of energy to the power grid, if the instantaneous yield of the generated energy exceeds 100% of the maximum yield of the generated energy, calculated in step g), in order to avoid an overload of the system;
is characterised in that the steps from c) to h) are carried out automatically by means of the artificial intelligence module comprising two neural networks, the first one of them being an RBF type (Radial Basis Function), and the second one being a PSO type (Particle Swarm Optimisation), wherein the first network (RBF) has a negative feedback loop comprising the second network (PSO) and aggregating the data generated by the second network (PSO).

Preferably, the elements generating energy from renewable energy sources are photovoltaic panels, or wind farms, or heat pumps.

Preferably, historical data on the prices of electrical energy in a given area are additionally transmitted to the server in step a).

Preferably, the data on the type of buildings and their function are additionally transmitted to the server in step a), and in the case of residential buildings, the data on the number of people inhabiting them are transmitted as well.

### DESCRIPTION OF THE DRAWINGS

FIG. 1 schematically presents the operating algorithm of a PSO-type neural network (Particle Swarm Optimisation).

FIG. 2 schematically presents the operating algorithm of an RBF-type neural network (Radial Basis Function).

FIG. 3 schematically presents the artificial intelligence module according to the invention, comprising two neural networks, the first one of them being the RBF type (Radial Basis Function), and the second one being the PSO type (Particle Swarm Optimisation).

FIG. 4 schematically presents the operation of a neural network for controlling a real object in reverse architecture.

FIG. 5 schematically presents the operation of a neural network for controlling a real object in architecture without feedback.

FIG. 6 schematically presents the implementation of the method according to the invention as an Internet platform.

### EXAMPLE

An exemplary embodiment of the invention is realised in the form of an electronic platform, enabling planning and adjustment to the individual needs of RES installations (Renewable Energy Sources), such as photovoltaic panels, energy storages, carports, solar roofs, heat pumps, wind turbines and farms.

Renewable energy sources (RES) constitute an alternative to traditional, primary nonrenewable energy carriers (fossil fuels). The utilisation of RES considerably reduces the harmful impact of the energy sector on the natural environment, mainly by reducing the emissions of harmful substances, especially greenhouse gases. In Poland, energy from renewable sources includes the energy of solar radiation, water, wind, geothermal resources, energy produced from solid biofuels, biogas, and liquid biofuels, as well as ambient energy collected by heat pumps.

In a preferable embodiment, the method is based on the technology of artificial intelligence implemented in an artificial intelligence module. The artificial intelligence module is installed on a remote server connected to the Internet. The artificial intelligence module is a set of machine instructions included in executable files realising the algorithm of processing the data contained in databases, or the data transmitted to the artificial intelligence module. The artificial intelligence module processes the acquired data, and uses their results for two basic purposes; the first purpose is self-regulation, commonly called learning, and the second one is using the results to control a process or a device. The artificial intelligence module according to the invention fulfils both these objectives. Said artificial intelligence module utilises geolocation data and systems monitoring insolation in a given area. Based on the data, including those about geolocation, the method according to the invention enables automatic planning of an RES installation consisting of the same or various types of devices for producing energy, with a maximum energy yield (understood as the maximum value of energy introduced into a power grid) on a roof and/or land indicated by the user.

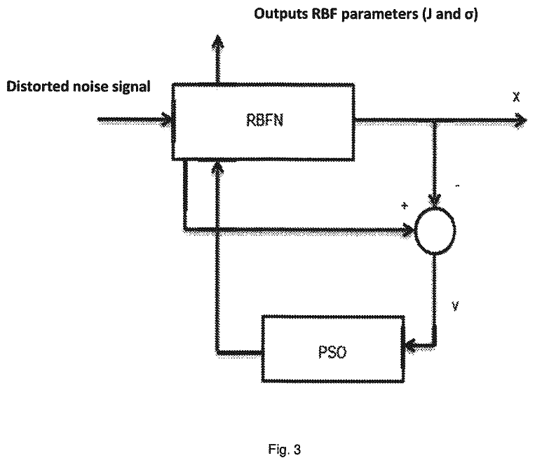

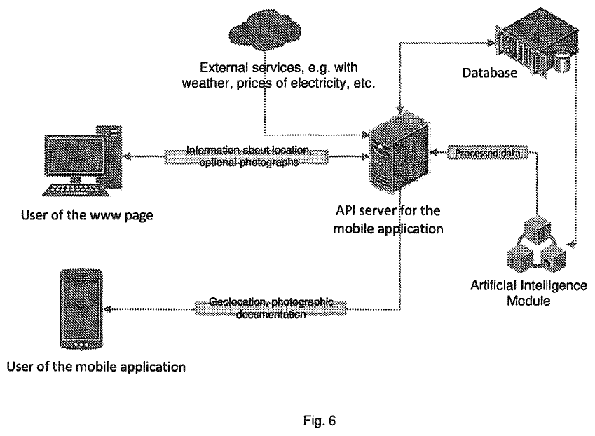

In a preferable exemplary embodiment, the artificial intelligence module is located on a remote server with access to a communication network, e.g. the Internet (FIG. 6). The artificial intelligence module used for calculation receives large amounts of historical data, including weather and geothermal data, as well as those on the terrain and vegetation (taking into account its growth or disappearance), along with the data on the demand for electrical energy [kWh], and the data on limiting the CO₂ emissions. The additional data transmitted to the artificial intelligence module are the data on the types and parameters of devices for the production of energy possible to use in a given area, taking their technical and legal limitations into account. In a preferable exemplary embodiment, the artificial intelligence module is used to create forecasts about the maximum yield of energy from a given area, taking all the provided data into account. The use of an artificial intelligence module, which has two neural networks, the first one of them being an RBF type (Radial Basis Function), and the second one being a PSO type (Particle Swarm Optimisation), wherein said first network (RBF) has a negative feedback loop comprising the second network (PSO) and aggregating data generated by the second network (PSO), enables acquiring the necessary precise data in a very short time (up to about a dozen minutes), with no need for their further mathematical or statistical processing (FIG. 3).

In a preferable exemplary embodiment, the artificial intelligence module comprises two types of neural networks. The first one is based on optimisation by means of a particle swarm (Particle Swarm Optimisation, in short: PSO); it is a metaheuristic algorithm used to solve optimisation problems.

An optimisation problem is a problem whose solution involves finding an optimal (the highest or the lowest) vale of a certain function, called an objective function. The range of the values of the arguments of this function is called a solution space. A single point in this space, indicated by the established values of specific arguments, is called a solution.

An example of an optimisation problem is the knapsack problem. Having a knapsack with a specific volume and a set of items having a specific value and size, it is necessary to determine a set of items with the highest possible value, without exceeding the volume of the knapsack. In the given example, the solution is a single specified subset of items, while the objective functions are determined by their total value. A solution space constitutes a set of all possible combinations of items which fit into the knapsack.

In an exemplary embodiment, the optimisation problem is the space of the roof and the land around the building, for planning a photovoltaic and wind installation, heat pumps, and a carport.

The idea of the PSO algorithm is an iterative search in the solution space of a problem by means of a particle swarm. Each of the particles has its position in the solution space, speed, and the direction in which it moves. Moreover, the best solution found so far by each particle (the local solution) is remembered along with the best solution from the entire swarm (the global solution). The speed of movement of individual particles depends on the position of the best global and local solution, and on the speed in the preceding steps. A formula enabling the calculation of the speed of a given particle is presented below.

$$v ← ω v + φ lrl ( l - x ) + φ g rg ( g - x )$$

### Where:

v—particle speed
ω—the inertia ratio; it defines the impact of speed in the preceding step
φl—the ratio of aiming at the best local solution
φg—the ratio of aiming at the best global solution
l—position of the best local solution
g—position of the best global solution
x—position of the particle
rl, rg—random values from a range of <0,1>

The above formula enables updating the speed of all particles based on the knowledge acquired so far.

The operating pattern of the algorithm is as follows:

For Each Particle from the Set:
Draw a starting position from the solution space
Save the current position of the particle as the best local solution
If this solution is better than the best global solution, save it as the best one

Draw an initial speed until the stop condition is fulfilled (e.g. a specific number of iterations are over) for each particle from the set:
Choose random values of the rl and rg parameters
Update the particle speed according to the above formula
Update the position of the particle in space
If the current solution is better than the best local solution:
Save the current solution as the best one locally
If the current solution is better than the best global solution:
Save the current solution as the best one globally

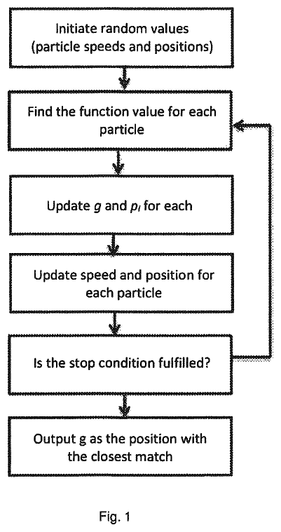

The action of the PSO algorithm (FIG. 1) can be controlled by selecting its parameters. Their values determine the behaviour of individual particles, the size of the space to be searched by the algorithm, and the time of convergence of particles to the best solution.

The value of the inertia ratio (w) influences the ability of the particles to maintain the previous speed. Along with an increase in the value of this parameter, the ability of the particles to search new regions in the solution space increases.
φl—the ratio of aiming at the best local solution. The higher the value of this parameter, the higher the tendency of the particle to oscillate around its best position.
φg—the ratio of aiming at the best global solution An increase in the value of this parameter causes an increase in the tendency of the particles to group around the best global solution.
Drawing The operating pattern of the PSO algorithm
Source: the author's own research.

In the PSO algorithm, the position of each particle is updated every generation. This proceeds by adding speed to the position vector in accordance with formula 1 below.

$${v}_{i} = {v}_{i} + {C}_{1} \times rand ( ) \times ( {p}_{i} - {x}_{i} ) + {C}_{2} \times rand ( ) \times ( g - {x}_{i} )$$

Formula 1—Updating a particle by adding speed to the position vector.

In each iteration, the position of each particle is updated based on its movement in a discrete time interval. This proceeds according to formula 2.

$${x}_{i} = {x}_{i} + {v}_{i} \times Δ t$$

Formula 2—Updating a particle based on its motion.

The parameters C1 and C2 are constant positive parameters called acceleration ratios, while rand( ) represents uniformly distributed random values.

Networks with radial basis functions, meaning RBF, are usually used to approximate numerical variables. The main difference compared to GLM and MLP networks is the different operating mode of the hidden layer, and the different training method. In networks with radial basis functions, neurons are distributed in the data space as the so-called centres.

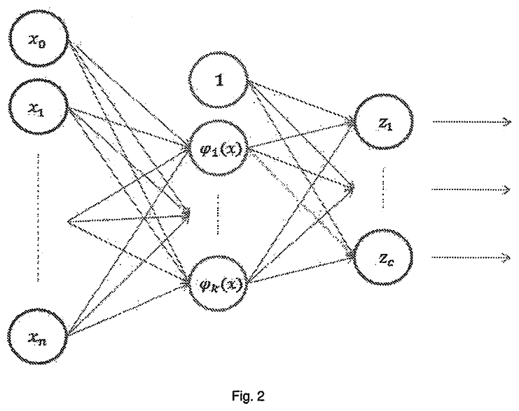

RBF networks consist of 3 layers. The first layer consists of source nodes for the signal, the second hidden layer—of radial functions, and the third one is the output layer (FIG. 2).

In RBF networks, the flow of information proceeds forward, with no exchange of information between neurons in a single layer. An RBF network is a network with the following architecture:

n inputs→K hidden→c outputs

The n, K, and c values are input by the user. In addition, one must determine a radial basis function G(r(x,c) processing the data in a hidden network.

A preferable exemplary embodiment uses a hybrid model, utilising the connection of the RBF network to the PSO network.

The PSO network in this exemplary embodiment is used to achieve proper RBF parameters, so as to achieve good filtering results. On the other hand, the RBF network is used to filter the noise of high frequencies, and to extract measurement noise from a covariance matrix. Training and the generation of results in an artificial intelligence module take place in all points except one, and by using error testing in this point. A minimum total error is obtained by repeating this process in all the points. FIG. 3 presents the functioning pattern of PSO-RBF.

In a preferable exemplary embodiment, the input data for the artificial intelligence module include geolocation (satellite maps), photographs of the surroundings taken by the user, and information data (parameters) from the user themselves:
The value of a monthly energy bill,
Main source of heating in home,
Does the building also have cooling?,
The energy source for heating water,
The number of people in the household,
Electrical installation in the building,
Geographic location,
Installation site,
Orientation and inclination,
One or two roof slopes,
geographical zone,
the number of inhabitants,
the heating area of the building,
the type of heating used,
current heating cost
What devices do I want to power?
Do I want a DC or an AC-type energy storage?

In a preferable exemplary embodiment, the method according to the invention enables obtaining a 5-10% improvement in the accuracy of calculations of the position of RES elements of the planned installation, and thus a 5-10% increase in the maximum energy output of a given area, at the same time protecting the system in the event of an unfavourable increase in the momentary value of the collected energy.

The action of the platform results in an individually adjusted executive design of an RES installation, comprising the arrangement of photovoltaic panels, the Mounting location of wind turbines, the location of heat pump boreholes, the location of a carport, in which the elements of the system are connected to the power grid by means of a coupling (a power connection with the ability to, manually or automatically, activate individual or all energy-generating devices). Energy couplings are known from prior art, as are the systems for controlling them.

In a preferable exemplary embodiment, the energy coupling will disconnect the energy-generating devices when the value of the energy collected therefrom exceeds the maximum value established during an analysis of the data. The purpose of the system is to increase the maximum energy output for typical weather conditions. A problem of such a solution is the nonzero probability of the occurrence of unexpectedly preferable weather conditions for each energy source, e.g. a hurricane on a cold, sunny day. Such a situation is dangerous for a system of energy-generating devices, and for the power grid. The construction of RES systems with a power limit, or those whose energy connections and couplings are capable of transmitting energy equal to the maximum theoretical power of all energy-generating devices, is extremely economically unpreferable. The maximum theoretical value of power will only be generable under highly unlikely (but still possible to occur) conditions. In a preferable embodiment, the parameters of an RES installation are established so as to maximise the output of electrical energy for a given area, and the weather conditions which exist in a given area (existed historically and can be predicted). Exceptional situations in which the output is too high can be predicted in advance, enabling safe disconnection of individual or all elements of an RES installation, protecting them and protecting the power grid. In a preferable embodiment, the increase in the energy output of an RES installation ranges between 5% and 10%.

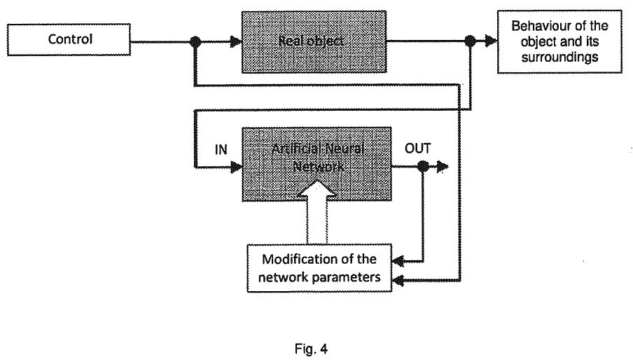

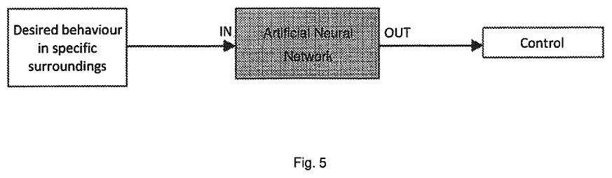

In a preferable exemplary embodiment, the proposed artificial intelligence module can be implemented in an operating control system of an RES system, both in simple (FIG. 5) and reverse architecture (FIG. 4).

1. A method for maximising an yield of energy generated from renewable energy sources in a given area, using a minimum number of energy-generating elements, and using an artificial intelligence module connected to a server, comprising the steps of:
a) Transmitting to a server historical weather data for a given area, types of elements generating energy from renewable energy sources fulfilling area requirements, as well as area geometry data, including data on: location of the area, terrain, shape and location of buildings in the area;
b) Transmitting the data from step a) to the artificial intelligence module;
c) Determining, by the artificial intelligence module, a vector field of solar irradiation intensity at a given time on every day in the year, for a given geometry of the area and objects located thereon, based on the data acquired in step b);
d) Determining, by the artificial intelligence module, a vector field of the direction and strength of the wind at a given time on every day in the year, for a given geometry of the area and objects located thereon, based on the data acquired in step b);
e) Determining, by the artificial intelligence module, a vector field of the temperature and moisture of ground at a given time on every day in the year, for a given geometry of the area and objects located thereon, based on the data acquired in step b);
f) Determining, by the artificial intelligence module, preferable and unpreferable zones for a given type of elements generating energy from renewable energy sources on the area, based on the data determined in steps d), e), and f);
g) Calculating a possible maximum yield output of the energy generated by elements generating energy from renewable energy sources in a given area;
h) Selection the type of elements generating energy from renewable energy sources, and planning their spatial distribution in the given area, so as to maximise the yield of the energy generated by these elements;
Installing elements generating energy from renewable energy sources according to the plan developed in step h), and connecting them to a power grid by through a shared energy coupling;
j) Activating the energy coupling, and transmitting the energy produced by the installation made in step i) to the power grid;
k) Disconnecting the energy coupling, and interrupting the transmission of energy to the power grid, if the instantaneous yield of the generated energy exceeds 100% of the maximum yield of the generated energy calculated in step g), in order to avoid an overload of the system;
characterised in that the steps from c) to h) are carried out automatically by means of the artificial intelligence module comprising two neural networks, the first one of them being an RBF type (Radial Basis Function), and the second one being a PSO type (Particle Swarm Optimisation), wherein first network (RBF) has a negative feedback loop comprising the second network (PSO) and aggregating the data generated by the second network (PSO).

2. The method for maximising the energy output according to claim 1, characterised in that the elements generating energy from renewable energy sources are photovoltaic panels, or wind farms, or heat pumps.

3. The method for maximising the energy output according to claim 1, characterised in that historical data on the prices of electrical energy in a given area are additionally transmitted to the server in step a).

4. The method for maximising the energy output according to claim 1, characterised in that the data on the type of buildings and their function are additionally transmitted to the server in step a), and in the case of residential buildings, the data on the number of people inhabiting them are transmitted as well.

5. The method for maximising the energy output according to claim 2, characterised in that historical data on the prices of electrical energy in a given area are additionally transmitted to the server in step a).

6. The method for maximising the energy output according to claim 2, characterised in that the data on the type of buildings and their function are additionally transmitted to the server in step a), and in the case of residential buildings, the data on the number of people inhabiting them are transmitted as well.

7. The method for maximising the energy output according to claim 3, characterised in that the data on the type of buildings and their function are additionally transmitted to the server in step a), and in the case of residential buildings, the data on the number of people inhabiting them are transmitted as well.
